(19) United States
(12) Patent Application Publication
(10) Pub. No.: US 2007/0063633 A1
(43) Pub. Date: Mar. 22, 2007

(54) IMAGE DISPLAY DEVICE AND METHOD OF MANUFACTURING THE SAME

(76) Inventors: Masahiro YOKOTA, Fukaya-shi (JP); Masaaki Furuya, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/557,988

(22) Filed: Nov. 9, 2006

Related U.S. Application Data
(63) Continuation of application No. PCT/JP05/08307, filed on May 2, 2005.

(30) Foreign Application Priority Data
May 10, 2004 (JP) 2004-140065

(51) Int. Cl. H01J 1/62; H01J 63/04

(52) U.S. Cl. 313/495; 313/292; 313/497

(57) ABSTRACT

A spacer structure is arranged between a first substrate and a second substrate located opposite each other with a gap therebetween. The spacer structure has a plurality of retaining portions held on one of the first and second substrates outside an image display region, at least one of the retaining portions having a tensioning mechanism which applies a tension in a direction parallel to the surfaces of the first and second substrates based on a force of pressure perpendicular to the surfaces of the first and second substrates.

### CROSS-REFERENCE TO RELATED APPLICATIONS

This is a Continuation Application of PCT Application No. PCT/JP2005/008307, filed May 2, 2005, which was published under PCT Article 21(2) in Japanese.

This application is based upon and claims the benefit of priority from prior Japanese Patent Application No. 2004-140065, filed May 10, 2004, the entire contents of which are incorporated herein by reference.

### BACKGROUND OF THE INVENTION

1. Field of the Invention

This invention relates to a flat-type image display device having substrates located opposite each other and spacers arranged between the substrates.

2. Description of the Related Art

In recent years, various image display devices have been developed as next-generation light-weight, small-thickness display devices, which will take the place of cathode-ray tubes (hereinafter, referred to as CRTs) . Such image display devices include liquid crystal displays (LCDs) which control the intensity of light by making use of alignment of liquid crystal, plasma display panels (PDPs) which cause phosphors to emit light by ultraviolet of plasma discharge, field emission displays (FEDs) which cause phosphors to emit light by electron beams of field-emission-type electron emitting elements, and surface-conduction electron-emitter displays (SEDs) which cause phosphors to emit light by electron beams of surface-conduction-type electron emitting elements.

The SED disclosed in Jpn. Pat. Appln. KOKAI Publication No. 2002-319346, for example, generally comprises a first substrate and a second substrate that are opposed to each other across a predetermined gap of 1 to 2 mm. These substrates have their respective peripheral portions joined together by a sidewall in the form of a rectangular frame, thereby forming a vacuum envelope. Three color phosphor layers are formed on the inner surface of the first substrate. Provided on the inner surface of the second substrate are a large number of electron emitting elements for use as electron emission sources, which excite the phosphors to luminescence. A plurality of spacers are provided between the first and second substrates in order to support an atmospheric-pressure load acting on these substrates and to maintain the gap therebetween.

The potential on the rear substrate side is substantially ground potential, and an anode voltage is applied to a fluorescent screen. An image is displayed by accelerating and colliding electron beams, which are emitted from the electron emitting elements, with a phosphor screen for luminescence based on a strong electric field applied between the rear substrate and the front substrate.

In the SED of this type, the thickness of the display device can be reduced to several millimeters or thereabout, so that the device can be made lighter and thinner than a CRT that is used as a display of an existing TV or computer.

For the SED described above, various manufacturing methods have been examined to manufacture a vacuum envelope. In a vacuum device, for example, the first and second substrates are kept fully apart from each other as they are baked, and the entire vacuum device is evacuated to a high vacuum. A method may be proposed such that the first substrate and second substrate are joined together with a sidewall when a predetermined temperature and degree of vacuum are reached. According to this method, a low-melting-point metal that can serve for sealing at a relatively low temperature is used as a sealing material.

In the SED constructed in this manner, in general, spacers that support an atmospheric load acting on the first and second substrates are formed as elongate integral spacer members that extend to the outside of an image display region lest their retaining portions lower the image display performance. The peripheral portions of the spacer members are held outside the image display region on the substrates. In order to locate the spacer members in appropriate positions, the spacer members must be tensioned or configured so as not to bend if not tensioned.

In manufacturing the vacuum envelope using the spacer members of which the peripheral portions are held on the substrates, however, there is a problem that the spacer members are easily damaged owing to a difference in thermal expansion between the substrates and the spacer members in a heat treatment process, such as baking. It is necessary, therefore, to perform the heat treatment process slowly by lengthening the time of the process to a range such that damage to the spacer members is allowable. In consequence, this requirement constitutes a significant factor that lowers productivity.

### BRIEF SUMMARY OF THE INVENTION

This invention has been made in consideration of these circumstances, and its object is to provide a flat-type image display device, capable of being efficiently manufactured without damage to spacer members, and a method of manufacturing the same.

In order to achieve the object, according to an aspect of the invention, there is provided an image display device comprising: an envelope which has a first substrate and a second substrate located opposite each other with a gap therebetween and having respective peripheral portions thereof joined together; and a spacer structure which is arranged between the first and second substrates and supports an atmospheric load acting on the first and second substrates,

the spacer structure having a plurality of retaining portions held on one of the first and second substrates outside an image display region, at least one of the retaining portions having a tensioning mechanism which applies a tension in a direction parallel to the surfaces of the first and second substrates based on a force of pressure perpendicular to the surfaces of the first and second substrates.

According to another aspect of the invention, there is provided an image display device comprising: an envelope which has a first substrate and a second substrate located opposite each other with a gap therebetween and having respective peripheral portions thereof joined together; and a spacer structure which is arranged between the first and second substrates and supports an atmospheric load acting on the first and second substrates, the spacer structure having a plurality of retaining portions held on one of the first and second substrates outside an image display region, at least one of the retaining portions being removably attached to the one of the first and second substrates.

According to another aspect of the invention, there is provided a method of manufacturing an image display device which comprises an envelope which has a first substrate and a second substrate located opposite each other with a gap therebetween and having respective peripheral portions thereof joined together, and a spacer structure which is provided between the first and second substrates and supports an atmospheric load acting on the first and second substrates, the spacer structure having a plurality of retaining portions held on one of the first and second substrates outside an image display region, at least one of the retaining portions having a tensioning mechanism which applies a tension in a direction parallel to the first and second substrates based on a force of pressure perpendicular to the surfaces of the first and second substrates, the method comprising: holding the spacer structure on at least one of the first and second substrates with the retaining portions and heat-treating the at least one substrate; sealing the other substrate to the at least one substrate after the heat treatment; and converting a force of pressure perpendicular to the surfaces of the first and second substrates into a tension in a direction parallel to the surfaces of the first and second substrates and applying the tension to the spacer structure by the tensioning mechanism during the sealing process.

According to still another aspect of the invention, there is provided a method of manufacturing an image display device which comprises an envelope which has a first substrate and a second substrate located opposite each other with a gap therebetween and having respective peripheral portions thereof joined together, and a spacer structure which is provided between the first and second substrates and supports an atmospheric load acting on the first and second substrates, the spacer structure having a plurality of retaining portions held on one of the first and second substrates outside an image display region, at least one of the retaining portions being removably attached to the one of the first and second substrates, the method comprising: heat-treating the first substrate and the second substrate; holding the spacer structure on the one of the first and second substrates by the removable retaining portions after the heat treatment; and sealing the heat-treated first and second substrates to each other.

### BRIEF DESCRIPTION OF THE SEVERAL VIEWS OF THE DRAWING

FIG. 1 is a perspective view showing an SED according to a first embodiment of this invention;

FIG. 2 is a perspective view of the SED cut away along line II-II of FIG. 1;

FIG. 3 is a sectional view of the SED taken along line III-III of FIG. 1;

FIG. 4 is a perspective view showing a second substrate and a spacer structure of the SED;

FIG. 5 is an exploded perspective view showing a retaining portion of a supporting substrate of the spacer structure;

FIG. 6 is a sectional view taken along line VI-VI of FIG. 1, showing configurations of substrates, the spacer structure, and the retaining portion in a heating process;

FIG. 7 is a sectional view showing configurations the substrates, the spacer structure, and the retaining portion after sealing;

FIG. 8 is a flowchart schematically showing manufacturing processes for the SED;

FIG. 9 is a diagram showing a change of temperature of the second substrate and a change of a difference in temperature between the second substrate and the spacer structure;

FIG. 10 is a sectional view showing configurations of substrates, a spacer structure, and a retaining portion of an SED in the heating process according to a second embodiment of this invention;

FIG. 11 is a sectional view showing configurations of the substrates, the spacer structure, and the retaining portion after sealing according to the second embodiment;

FIG. 12 is a perspective view showing a spacer structure and a retaining portion of an SED according to a third embodiment of this invention;

FIG. 13 is a perspective view showing a second substrate and a spacer structure of an SED according to a fourth embodiment of this invention;

FIG. 14 is a sectional view of the SED according to the fourth embodiment;

FIG. 15 is a plan view showing the spacer structure of the SED according to the fourth embodiment;

FIG. 16 is a sectional view showing configurations of substrates, the spacer structure, and a retaining portion of the SED in the heating process according to the fourth embodiment;

FIG. 17 is a sectional view showing configurations of the substrates, the spacer structure, and the retaining portion after sealing according to the fourth embodiment;

FIG. 18 is a plan view showing a spacer structure of an SED according to a fifth embodiment of this invention;

FIG. 19 is a sectional view showing configurations of substrates, the spacer structure, and a retaining portion of the SED in the heating process according to the fifth embodiment;

FIG. 20 is a sectional view showing configurations of the substrates, the spacer structure, and the retaining portion after sealing according to the fifth embodiment;

FIG. 21 is a sectional view showing a spacer structure of an SED according to a sixth embodiment of this invention; and

FIG. 22 is a plan view showing a spacer structure of an SED according to a seventh embodiment of this invention.

### DETAILED DESCRIPTION OF THE INVENTION

A first embodiment in which this invention is applied to an SED as a flat-type image display device will now be described in detail with reference to the drawings.

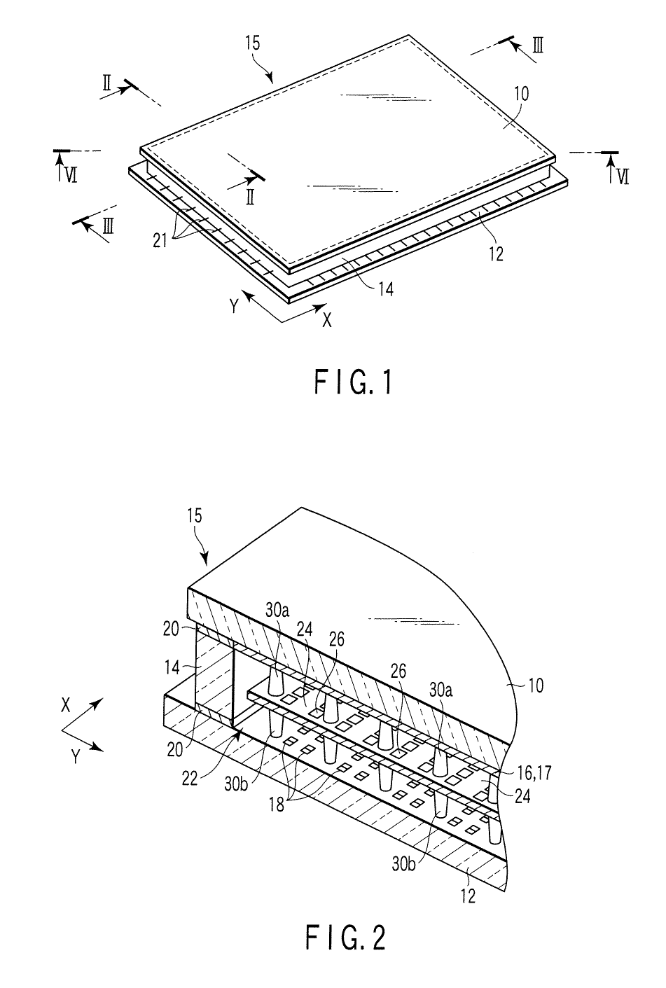

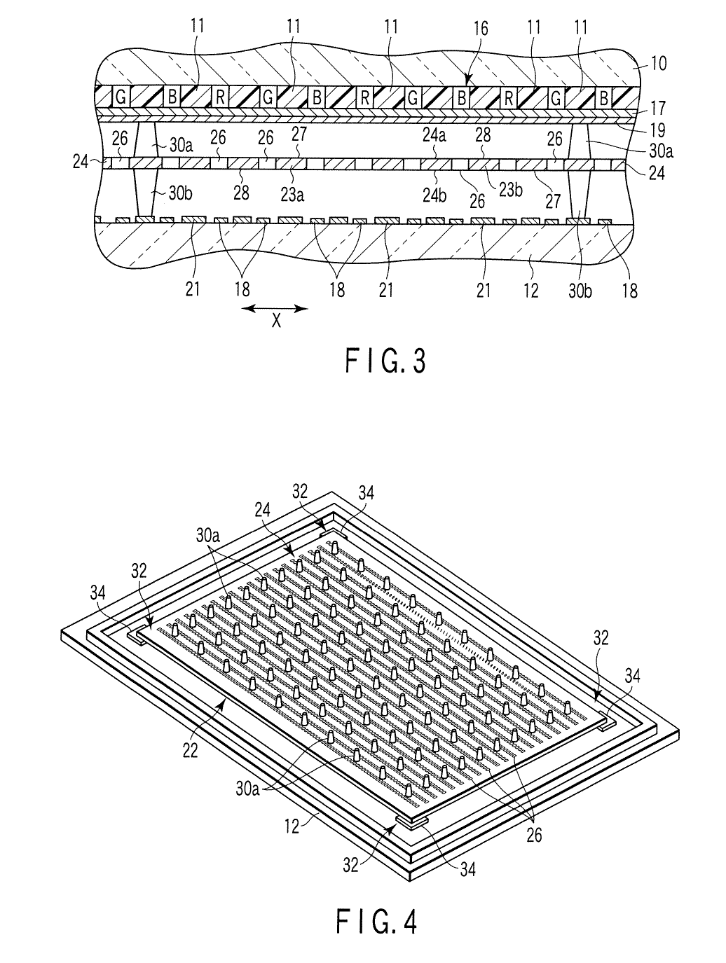

As shown in FIG. 1 to FIG. 3, the SED includes a first substrate 10 and a second substrate 12, each of which is formed of a rectangular glass plate. The first substrate 10 and second substrate 12 are disposed to be opposed to each other with a gap of 1 to 2 mm. Peripheral edge parts of the first substrate 10 and second substrate 12 are joined via a rectangular-frame-shaped side wall 18, thereby forming a flat, rectangular vacuum envelope 15 in which a vacuum is maintained.

A phosphor screen 16 which functions as a phosphor surface is formed on the inner surface of the first substrate 10. The phosphor screen 16 is formed of phosphor layers R, G and B, which glow red, green, and blue, respectively, and light shielding layers 11 arranged side by side. These-phosphor layers are stripe-shaped, dot-shaped, or rectangular. A metal back layer 17 formed of, e.g. aluminum, and a getter film 19 are successively stacked on the phosphor screen 16.

Provided on the inner surface of the second substrate 12 are a large number of electron emitting elements 18, which individually emit electron beams as electron emission sources for exciting the phosphor layers R, G and B of the phosphor screen 16. These electron emitting elements 18 are arranged in a plurality of columns and a plurality of rows corresponding to one another for each pixel. Each electron emitting element 18 is composed of an electron emitting portion (not shown), a pair of element electrodes for applying a voltage to the electron emitting portion, and the like. A number of wires 21 that supply potential to the electron emitting elements 18 are arranged in a matrix on the inner surface of the second substrate 12, and their respective end portions are drawn out of the vacuum envelope 15.

The sidewall 14 that functions as a joint member is sealed to the peripheral edge portion of the first substrate 10 and the peripheral edge portion of the second substrate 12 by a sealing member 20, such as low-melting-point glass or low-melting-point metal, whereby the substrates are joined together.

As shown in FIGS. 2 to 4, the SED has a spacer structure 22 that is located between the first substrate 10 and the second substrate 12. The spacer structure 22 has a supporting substrate 24, which is formed of a rectangular metal plate located between the first substrate 10 and the second substrate 12, and a number of columnar spacers set up integrally on the opposite surfaces of the supporting substrate. The spacer structure 22 is located covering an entire image display region.

The supporting substrate 24 of the spacer structure 22 is formed rectangular in shape, has a first surface 24a opposed to the inner surface of the first substrate 10 and a second surface 24b opposed to the inner surface of the second substrate 12, and is located parallel to these substrates. The supporting substrate 24 is formed having a size larger than those of the respective image display regions of the first and second substrates 10 and 12, and its peripheral edge portion faces the outside of the image display regions.

A number of electron beam passage apertures 26 are formed in the supporting substrate 24 by etching or the like. The electron beam passage apertures 26 are arranged in a plurality of rows and a plurality of columns. If the extending direction of the respective long sides of the vacuum envelope 15 and the supporting substrate 24 and the extending direction of their respective short sides are a first direction X and a second direction Y, respectively, the electron beam passage apertures 26 are arranged at first pitches in the first direction X with bridge portions between them and at second pitches greater than the first pitches in the second direction Y. The electron beam passage apertures 26 are arrayed opposite the electron emitting elements 18, individually, and are permeated by electron beams emitted from the electron emitting elements.

A plurality of first spacers 30a are set up integrally on the first surface 24a of the supporting substrate 24 and situated individually between the electron beam passage apertures 26 that are arranged in the second direction Y. The respective distal ends of the first spacers 30a abut against the inner surface of the first substrate 10 interposing the getter film 19, the metal back 17, and the light shielding layers 11 of the phosphor screen 16.

A plurality of second spacers 30b are set up integrally on the second surface 24b of the supporting substrate 24 and are situated individually between the electron beam passage apertures 26 that are arranged in the second direction Y. The respective distal ends of the second spacers 30b abut against the inner surface of the second substrate 12. In this case, the respective distal ends of the second spacers 30b are situated individually on the wires 21 that are provided on the inner surface of the second substrate 12. The first and second spacers 30a and 30b are situated in alignment with one another and are formed integrally with the supporting substrate 24 in a manner such that the supporting substrate 24 is held between them from both sides.

Each of the first and second spacers 30a and 30b is tapered so that its diameter is reduced from the side of the supporting substrate 24 toward its extended end. For example, each of the first and second spacers 30a and 30b has a substantially elliptical cross section.

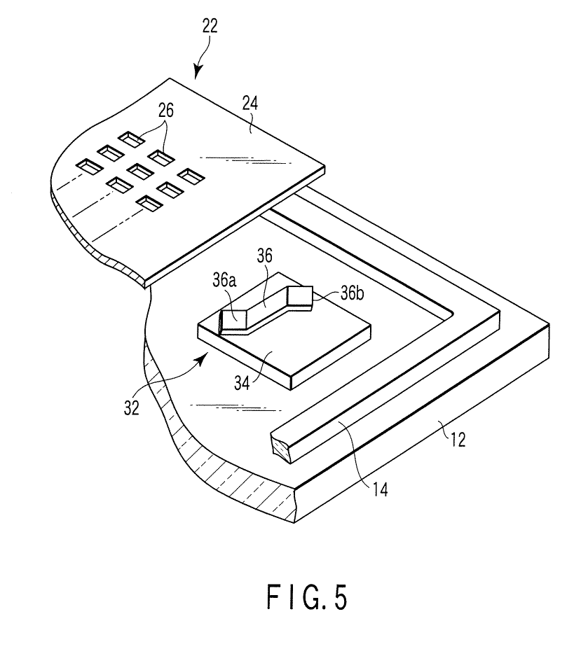

As shown in FIGS. 4 to 7, the spacer structure 22 constructed in this manner is located in a manner such that the long sides of the supporting substrate 24 extend parallel to the first direction X of the second substrate 12. Each corner portion of the supporting substrate 24 is fixed to the second substrate 12 by a retaining portion 32. Each retaining portion 32 has a fixing base 34 in the form of a rectangular plate fixed to the inner surface of the second substrate 12 and a tensioning mechanism that applies tension to the supporting substrate 24 of the spacer structure 22. The tensioning mechanism has a connecting member 36, which connects the fixing base 34 and each corner portion of the supporting substrate 24, and a press portion 38 in the form of a rectangular plate that is fixed to the inner surface of the first substrate 10 and opposed to the fixing base 34.

The press portion 38 and the fixing base 34 are individually formed of, for example, metal and are fixed to the first and second substrates 10 and 12 with an inorganic adhesive agent, frit glass, etc. The connecting member 36 is formed of a belt-shaped metal plate, its one end portion 36a is, for example, molded integrally with the fixing base 34, and its other end portion 36b is, for example, welded to the inner surface of each corner portion of the supporting substrate 24. The connecting member 36 extends in the diagonal-axis direction of the supporting substrate 24, and the other end portion 36b is situated outside the one end portion 36a with respect to the diagonal direction of the supporting substrate.

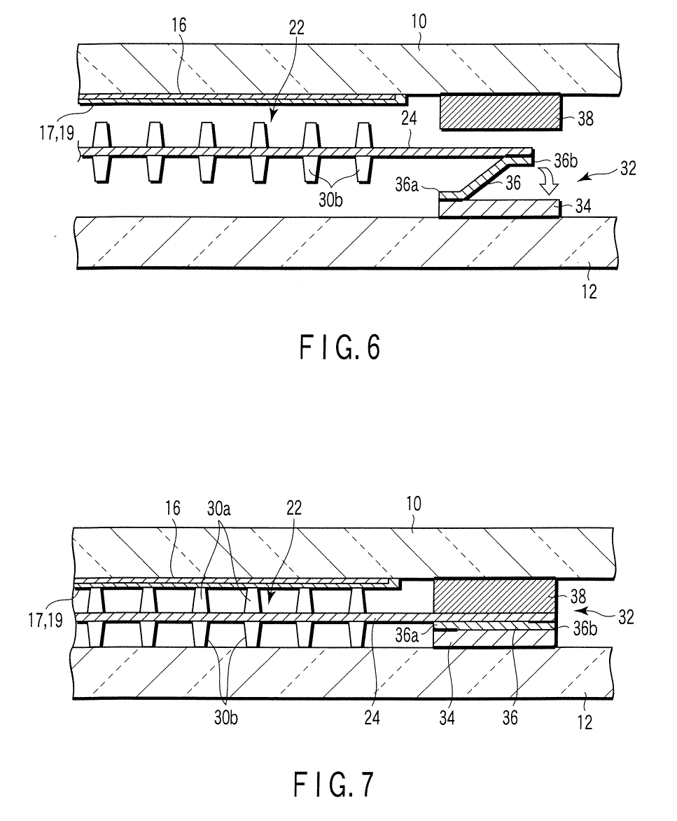

Before the first substrate 10 and the second substrate 12 are sealed to each other, as shown in FIG. 6, the connecting member 36 extends declining from the first substrate side toward the second substrate side and elastically supports the spacer structure 22 in a state such that the spacer structure 22 floats above the second substrate 12. Thus, the connecting member 36 can ease a stress that acts on the spacer structure 22.

When the first substrate 10 and the second substrate 12 are sealed to each other, as shown in FIG. 7, the other end portion 36b of the connecting member 36 is pressurized in a direction perpendicular to the substrate surfaces by the press portion 38 that is fixed to the first substrate 10. Thereupon, the connecting member 36 rocks around the one end portion 36a to be flattened and its whole area touches the fixing base 34. Thus, each corner portion of the supporting substrate 24 and the connecting member 36 is sandwiched between the fixing base 34 and the press portion 38, whereupon the spacer structure 22 is held in a predetermined position with respect to the first and second substrates 10 and 12. As the connecting member 36 rocks, moreover, the supporting substrate 24 is pulled outward in the diagonal direction and subjected to a tension parallel to the first and second substrates 10 and 12. Thus, the tensioning mechanism converts a force of pressure perpendicular to the substrate surfaces into a tension that acts on the spacer structure. In order to reduce swings with respect to directions other than the rocking direction, the connecting member 36 is formed in the shape of a flat plate such that its stiffness is considerably low in the rocking direction only.

The first and second spacers 30a and 30b of the spacer structure 22 thus held by the retaining portion 32 abut against the respective inner surfaces of the first substrate 10 and the second substrate 12, thereby supporting an atmospheric load that acts on these substrates and keeping the space between the substrates at a predetermined value.

The SED comprises voltage supply portions (not shown) that apply voltages to the supporting substrate 24 and the metal back 17 of the first substrate 10. The voltage supply portions are connected individually to the supporting substrate 24 and the metal back 17, and apply voltages of, e.g., 12 kV and 10 kV to the supporting substrate 24 and the metal back 17, respectively. In displaying an image on the SED, an anode voltage is applied to the phosphor screen 16 and the metal back 17, and electron beams emitted from the electron emitting elements 18 are accelerated by the anode voltage and collided with the phosphor screen 16. Thereupon, the phosphor layers of the phosphor screen 16 are excited to luminescence and display the image.

The following is a description of a method of manufacturing the SED constructed in this manner.

The first substrate 10, which is provided with the phosphor screen 16, metal back 17, and press portion 38, and the second substrate 12, which is provided with the electron emitting elements 18 and the wires 21 and joined with the sidewall 14 and the fixing base 34, are prepared first. Further, the spacer structure 22 is formed. Then, the spacer structure 22 is positioned with respect to second substrate 12, and the four corner portions of the supporting substrate 24 are fixed individually to the fixing bases 34 by means of the connecting members 36. In this state, the spacer structure 22 is elastically supported by the connecting members 36 in a manner such that it floats above the second substrate 12, as shown in FIG. 6.

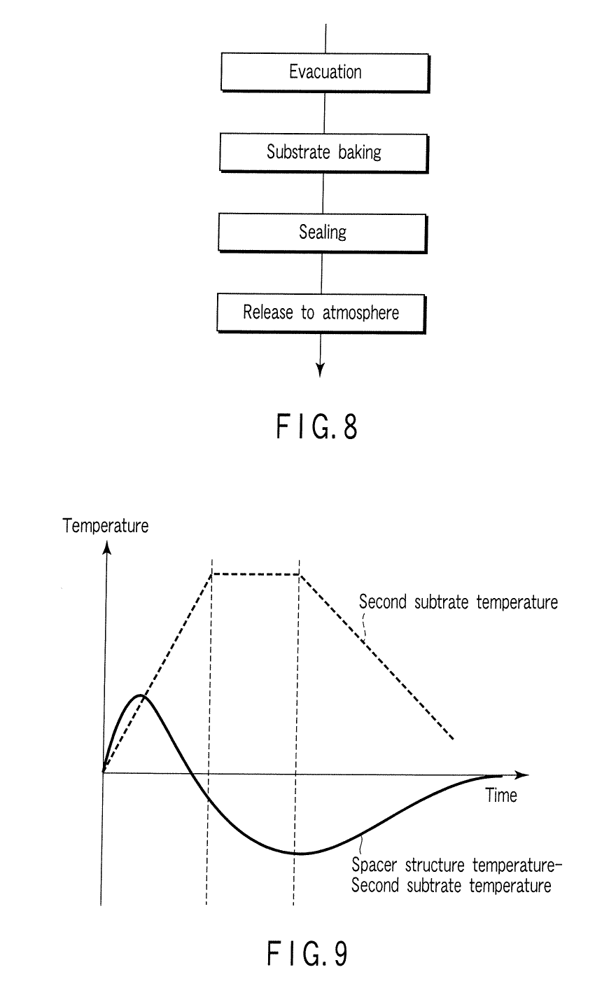

Subsequently, as shown in FIG. 8, the second substrate 12, mounted with the spacer structure 22, and the first substrate 10 are put into a vacuum chamber, and this vacuum chamber is evacuated to a given degree of vacuum. Then, the various members are baked by being heated to a temperature of about 350° C. in a vacuum ambience, whereupon gas that is adsorbed by the surface of each substrate is released. Since the spacer structure 22 is elastically supported by the connecting members 36 when this is done, the stress that acts on the spacer structure 22 can be eased.

While kept in the vacuum ambience, thereafter, the first substrate 10 and the second substrate 12 are pressurized toward each other, and the first substrate 10 is sealed to the sidewall 14 with a sealing material such as indium. When this is done, as shown in FIG. 7, the corresponding connecting members 36 pushed in the direction perpendicular to the substrate surfaces to be rocked by the press portions 38 on the side of the first substrate 10. Thereupon, the corner portions of the supporting substrate 24 and the connecting members 36 are sandwiched between the fixing bases 34 and the press portions 38, whereby the spacer structure 22 is held in the predetermined position with respect to the first and second substrates 10 and 12. As the connecting members 36 rock, moreover, the supporting substrate 24 is pulled in four diagonal directions and subjected to a tension parallel to the first and second substrates 10 and 12. The vacuum envelope is formed by taking out the resulting structure into the atmosphere after the sealing.

In the aforesaid heat treatment process, as shown in FIG. 9, a temperature difference is generated between the second substrate 12 and the spacer structure 22 during transition from a heating peak to cooling. This is done because the heat capacity of the spacer structure 22 with a smaller volume is so much smaller than that of the second substrate 12 that the temperature is changed very quickly by heat reception and radiation, for example. If the amount of thermal expansion of the spacer structure 22 becomes larger than that of the spacer structure 22 during the heat treatment process, the spacer structure 22 is pulled from the peripheral retaining portions, so that a great tension develops in the spacer members. According to the present embodiment, however, the spacer structure 22 is elastically supported floating above the second substrate 12 by the connecting members 36 during the heat treatment process, e.g., baking. Therefore, the stress that acts on the spacer structure 22 can be eased, so that the spacer structure can be prevented from being damaged. After the sealing, a desired tension is applied to the supporting substrate 24 of the spacer structure 22 by the tensioning mechanisms, so that the spacer structure can be located accurately in the predetermined position.

According to the SED constructed in this manner and the manufacturing method therefor, the spacer structure can be prevented from being damaged by a difference in thermal expansion even when the heat-treated substrates have the spacer structure of which the peripheral portion is held. Accordingly, the heat treatment can be performed with a large heat load in a short time, so that the productivity can be improved considerably.

In the first embodiment described above, the tensioning mechanisms for the spacer structure 22 are provided individually at the four corner portions of the supporting substrate 24. However, they may be provided individually on the side portions of the supporting substrate in place of the corner portions. Further, one of two diagonally opposite corner portions of the supporting substrate 24 may be fixed to the substrates. In this case, only the other corner portion is held by means of a tensioning mechanism. Further, the supporting substrate may be fixed on the first substrate side. The spacer structure may be composed of a plurality of elongated plate-shaped spacers such that at least one end portion of each spacer is held on one substrate by means of the tensioning mechanism.

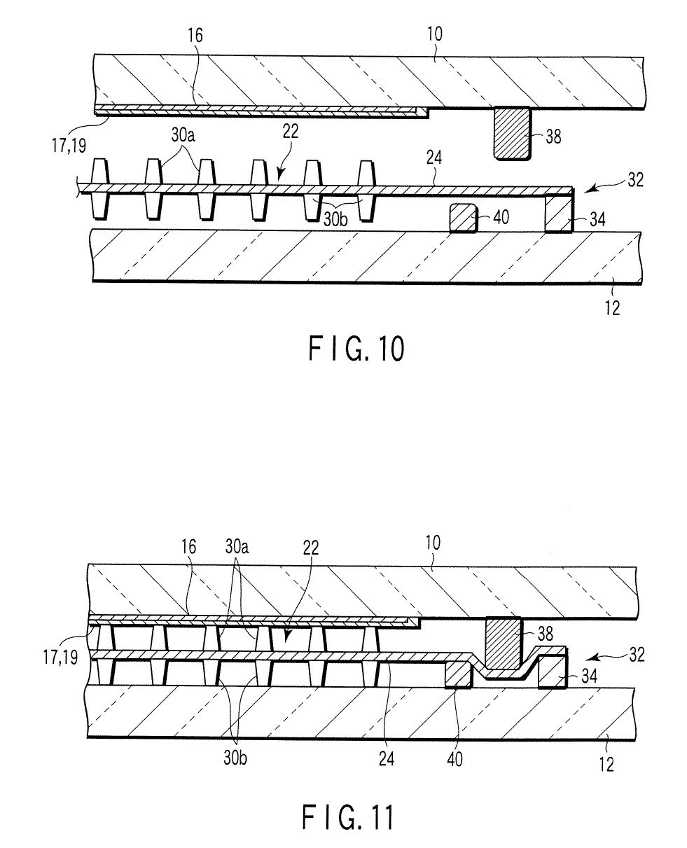

The following is a description of a second embodiment of this invention. The present embodiment differs from the first embodiment in the respective configurations of retaining portions and tensioning mechanisms that hold the supporting substrate 24 of the spacer structure 22. According to the second embodiment, as shown in FIGS. 10 and 11, a retaining portion 32 that holds each corner portion of a supporting substrate 24 that constitutes a spacer structure 22 has a cubic fixing base 34 fixed to the inner surface of a second substrate 12, a cubic height regulating member 40 fixed to the inner surface of the second substrate 12 inside the fixing base, and a tensioning mechanism that applies tension to the supporting substrate 24 of the spacer structure 22. The tensioning mechanism has a press portion 38 in the form of a rectangular plate that is fixed to the inner surface of a first substrate 10 and opposed to a space between the fixing base 34 and the height regulating member 40.

The press portion 38 and the height regulating member 40 are individually formed of, for example, glass, while the fixing base 34 is formed of, for example, metal. They are fixed to the first and second substrates 10 and 12 with an inorganic adhesive agent, frit glass, etc. The height regulating member 40 is formed having a height substantially equal to that of second spacers 30b that are situated on the side of the second substrate 12. The fixing base 34 is formed higher than the height regulating member 40. Each corner portion of the supporting substrate 24 is fixed on the fixing base 34 by, for example, welding.

Before the first substrate 10 and the second substrate 12 are sealed to each other, as shown in FIG. 10, the supporting substrate 24 that is fixed to the fixing base 34 is kept apart from the height regulating member 40, and the spacer structure 22 is supported floating above the second substrate 12. Further, the supporting substrate 24 is kept loosely sagging with respect to its surface direction. Even when the spacer structure 22 is heat-treated together with the second substrate 12 during manufacture, therefore, stress that is attributable to a difference in thermal expansion compared with the substrates can be reduced to prevent damage.

When the first substrate 10 and the second substrate 12 are sealed to each other, as shown in FIG. 11, each corner portion of the supporting substrate 24 is pressurized in a direction perpendicular to the substrate surfaces by the press portion 38, which is fixed to the first substrate 10, and is pushed in between the fixing base 34 and the height regulating member 40. Thereupon, the supporting substrate 24 engages the height regulating member 40 and is held in a predetermined height position. As the corner portion is squeezed between the fixing base 34 and the height regulating member 40, moreover, the supporting substrate 24 is pulled in the diagonal directions and subjected to a tension parallel to the first and second substrates 10 and 12. Thus, the spacer structure 22 is located in a predetermined position such that it is subjected to a desired tension. In this manner, the tensioning mechanism converts a force of pressure perpendicular to the substrate surfaces into a tension that acts on the spacer structure.

In the second embodiment, other configurations of an SED are the same as those of the foregoing first embodiment, so that like reference numerals are used to designate like portions, and a detailed description thereof is omitted. Further, the same functions and effects of the first embodiment can be obtained with the second embodiment.

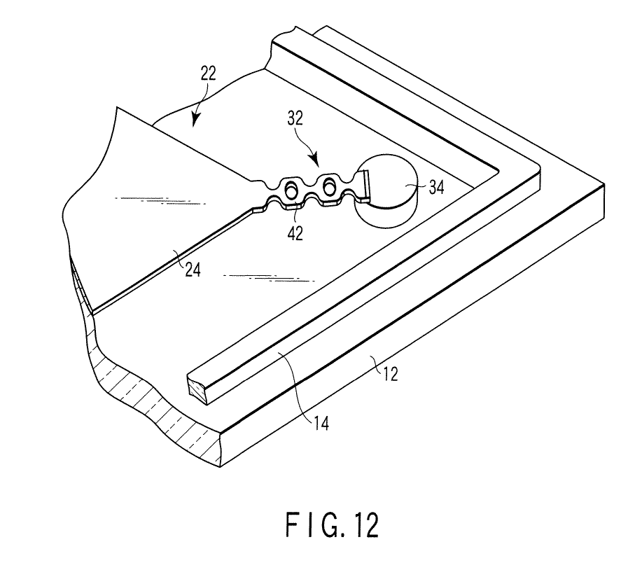

The following is a description of a third embodiment of this invention. The present embodiment differs from the first embodiment in the respective configurations of retaining portions that hold the supporting substrate 24 of the spacer structure 22. According to the third embodiment, as shown in FIG. 12, a retaining portion 32 that holds each corner portion of a supporting substrate 24 that constitutes a spacer structure 22 has a fixing base 34 fixed to the inner surface of a second substrate 12 and a buffer portion 42 that connects the fixing base and the supporting substrate 24. The buffer portion 42 extends along a diagonal axis from the corner portion of the supporting substrate 24 and has a bellows structure. The buffer portion 42 is formed of the same material as and integrally with the supporting substrate 24. An extended end of the buffer portion 42 is fixed on the fixing base 34.

The buffer portion 53, based on the bellows structure, is designed for flexibility such that its modulus of elasticity in the direction of the tension that acts on the spacer structure 22 is lower than that of the supporting substrate 24. In the heat treatment process, therefore, the buffer portion 42 can alternatively extend or contract to ease a stress that acts on the spacer structure 22.

In the third embodiment, other configurations of an SED are the same as those of the foregoing first embodiment, so that like reference numerals are used to designate like portions, and a detailed description thereof is omitted. Further, the same functions and effects of the first embodiment can be obtained with the third embodiment.

Although the spacer structure used in each of the foregoing embodiments is a planar spacer structure that comprises a supporting substrate and a plurality of columnar spacers, this invention is not limited to this form, and an elongated plate-shaped spacer structure can be used instead.

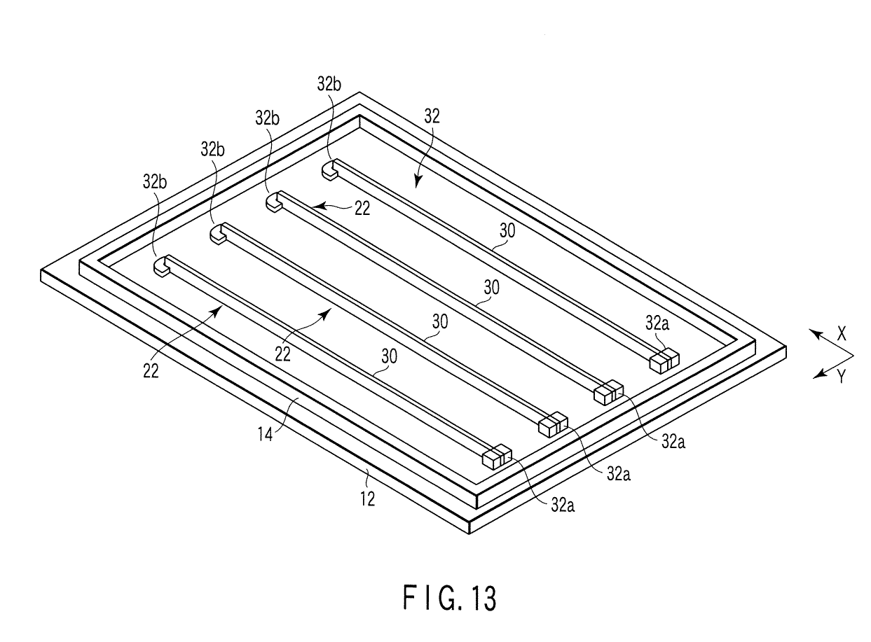

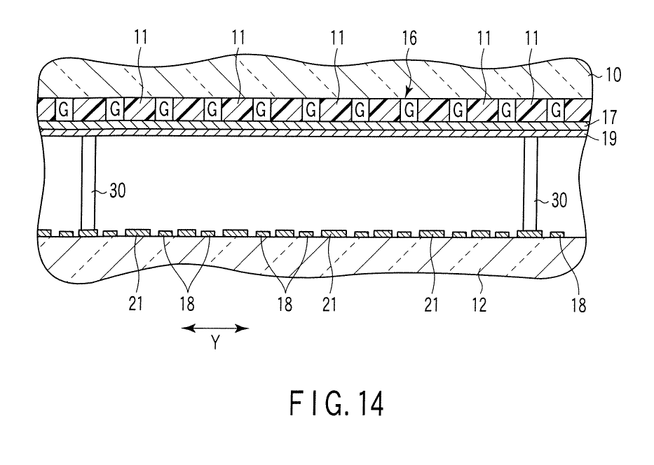

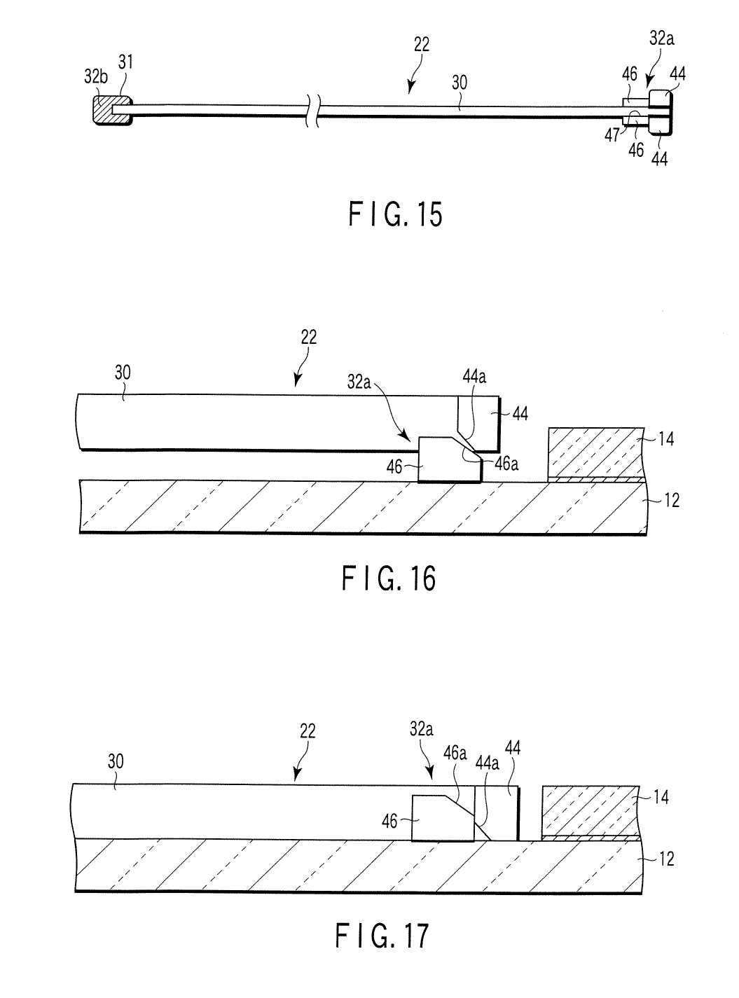

As shown in FIGS. 13 to 15, an SED according to a fourth embodiment of this invention comprises a plurality of spacer structures 22 that are provided on a second substrate 12. Each spacer structure 22 has a spacer 30 of, e.g., glass in the form of an elongated plate and a pair of retaining portions that individually hold the opposite end portions of the spacer 30. A plurality of spacers 30 extend in the first direction X parallel to the long sides of the second substrate 12 and are arranged at distances from one another in the second direction Y parallel to the short sides. Each spacer 30 extends in an image display region of the SED, and its opposite end portions extend to the outside of the image display region. Each spacer 30 is set upright on a surface of the second substrate 12. One side edge of each spacer 30 engages the inner surface of a first substrate 10, and the other side edge engages the inner surface of the second substrate 12, thereby supporting an atmospheric load that acts on these substrates and keeping the space between the substrates at a predetermined value.

As shown in FIGS. 13 to 17, each spacer structure 22 comprises a first retaining portion 32a and a second retaining portion 32b. The first retaining portion 32a holds one end portion of the spacer 30 so that it is removably attached to the second substrate 12 outside the image display region thereof. The second retaining portion 32b holds the other end portion of the spacer so that it is fixed to the second substrate 12 outside the image display region thereof. The second retaining portion 32b is formed of, e.g., frit glass 31, which fixes the other end portion of the spacer 30 to the inner surface of the second substrate 12.

The first retaining portion 32a of each spacer structure 22 is provided with a pair of guide members 46, which are fixed on the inner surface of the second substrate 12 outside the image display region, and a pair of hooks 44, which are fixed individually to the opposite surfaces of the one end portion of the spacer 30 and engage the guide members 46, individually. The pair of guide members 46 are formed of, e.g., glass, and are fixed to the inner surface of the second substrate 12 with an inorganic adhesive agent or the like. The pair of guide members 46 are arranged with a gap between them, and a positioning groove 47 that extends in the first direction X is defined between these guides. A guide surface 46a that is inclined at an angle to the second substrate surface is formed on an upper end portion of each guide member 46 that is situated on the side of the sidewall 14.

The pair of hooks 44 are formed of, e.g., glass, and are fixed individually to the opposite surfaces of the one end portion of the spacer 30 with an inorganic adhesive agent or the like. These hooks 44 protrude in opposite directions from the spacer 30. A guide surface 44a that is inclined at an angle to the second substrate surface is formed on an end portion of each hook 44 on the side of the second substrate 12.

In the heat treatment before the first substrate (not shown) and the second substrate 12 are sealed to each other, the hooks 44 of each spacer structure 22 are disengaged from the guide members 46, and the one end portion of the spacer 30 is supported floating above the second substrate 12, as shown in FIG. 16. Thus, even if a difference in thermal expansion is generated between the second substrate 12 and the spacer structure 22 in the heat treatment process, the hooks 44 of the spacer 30 slide on the guide members at the first retaining portion 32a, thereby restraining generation of a stress of such a magnitude as to cause damage.

When the first substrate and the second substrate 12 are sealed to each other, as shown in FIG. 17, the hooks 44 of each spacer structure 22 engage the outside of their corresponding guide members 46 and are held hitched. As this is done, a hooked state can be easily established by sliding the hooks 44 and the guide members 46 along the guide surfaces 44a and 46a with a force to pressurize the first substrate 10. At the same time, the one end portion of the spacer 30 is inserted into the positioning groove 47 between the pair of guide members 46 and positioned with respect to the second direction Y by the pair of guide members. When the hooks 44 are anchored to the guide members 46, a tension in the longitudinal direction is applied to the spacer 30 by the guide members 46. Thus, the spacer 30 is positioned with an accuracy of several micrometers or thereabout in the image display region.

In the fourth embodiment, other configurations of the SED are the same as those of the foregoing first embodiment, so that like reference numerals are used to designate like portions, and a detailed description thereof is omitted. According to the SED of the fourth embodiment and a manufacturing method therefor, the spacer structure can be prevented from being damaged by a difference in thermal expansion even when the heat-treated substrates have the spacer structure of which the peripheral portion is held. Accordingly, the heat treatment can be performed with a large heat load in a short time, so that productivity can be improved considerably.

According to the fourth embodiment, a fixed end is provided on the one end side of each spacer 30, and the spacer is heated together with the substrates in the heat treatment process therefor. Alternatively, however, both the first and second retaining portions of the spacer may be configured to be removable so that the spacer structure can be assembled on the substrates after the heat treatment process for the substrates. Although the vacuum envelope is manufactured consistently in a vacuum ambience according to the foregoing embodiments, a heat treatment process in the atmosphere may be applied for this purpose. Further, the aforesaid removable retaining portions may be applied to the planar spacer structures described in connection with the first and second embodiments.

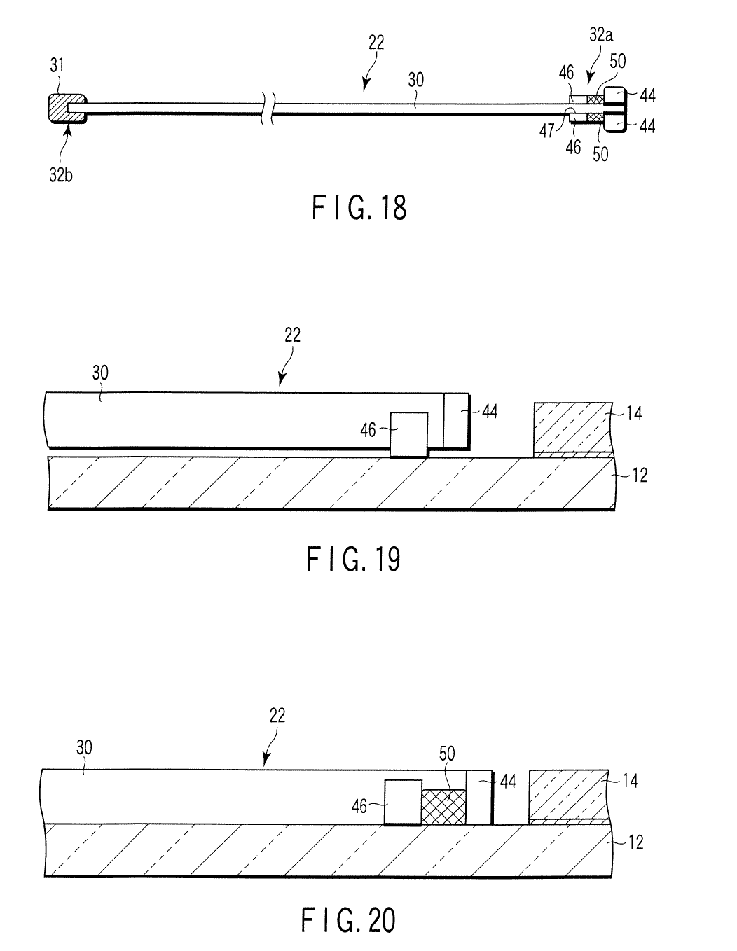

According to a fifth embodiment shown in FIGS. 18 to 20, removable supporting portions have alternative configurations. Specifically, each spacer structure 22 comprises an elongated plate-shaped spacer 30, a first retaining portion 32a, and a second retaining portion 32b. The first retaining portion 32a holds one end portion of the spacer 30 so that it is removably attached to a second substrate 12 outside the image display region thereof. The second retaining portion 32b holds the other end portion of the spacer so that it is fixed to the second substrate 12 outside the image display region thereof. The first retaining portion 32a is provided with a pair of guide members 46, which are fixed on the inner surface of the second substrate 12 outside the image display region, and a pair of hooks 44, which are fixed individually to the opposite surfaces of the one end portion of the spacer 30 and protrude in opposite directions from the spacer 30. Each hook 44 is opposed to each guide member 46 across a gap. Further, a wedge member 50 of, e.g., glass is closely inserted between each hook 44 and the guide member 46. Thereupon, a tension in the longitudinal direction is applied to the spacer 30 by the guide members 46 and the wedge members 50. The spacer 30 is positioned with an accuracy of several micrometers or thereabout in the image display region.

In the heat treatment process, as shown in FIG. 19, the hook 44 of each spacer structure 22 is positioned with a gap between itself and the guide member 46. Even if a difference in thermal expansion is generated between the second substrate 12 and the spacer structure 22 in the heat treatment process, therefore, generation of a stress of such a magnitude as to damage the spacer structure 22 can be restrained.

In a heating process, as shown in FIG. 20, the wedge member 50 is inserted between each hook 44 and the guide member 46 so that an appropriate tension is applied to the spacer 30. In the process for inserting the wedge member 50, the spacer 30 on the second substrate 12 is slightly heated before the sealing process. If this is done, the spacer 30 is quickly thermally expanded, so that the gap between the hook 44 and the guide member 46 enlarged. When the spacer 30 is cooled and contracted, thereafter, the wedge member 50 is firmly held between the hook 44 and the guide member 46. The wedge member 50 can be easily inserted by this process.

In the fifth embodiment, other configurations of an SED are the same as those of the foregoing fourth embodiment, so that like reference numerals are used to designate like portions, and a detailed description thereof is omitted. Further, the same functions and effects of the fourth embodiment can be obtained with the fifth embodiment.

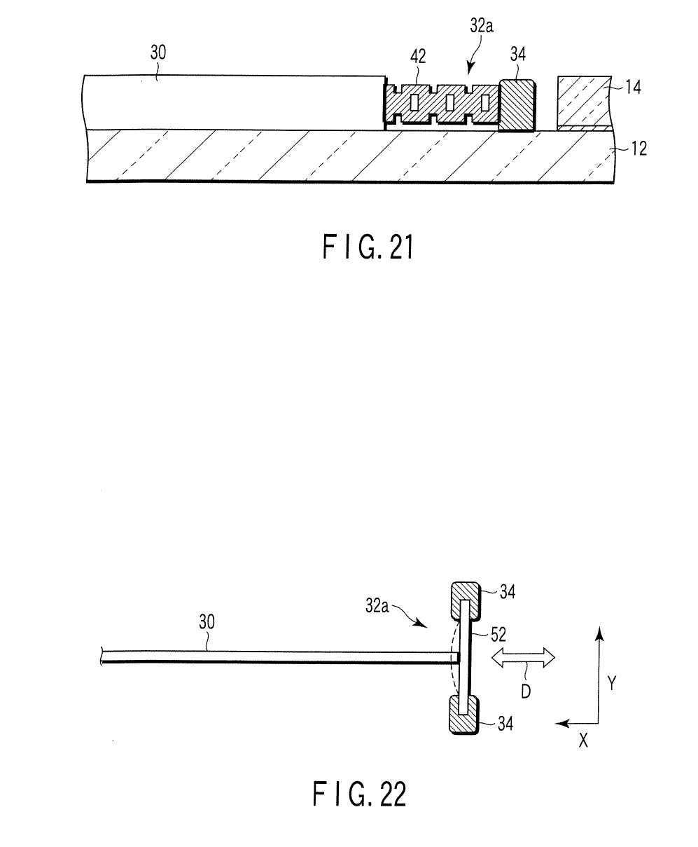

The following is a description of a sixth embodiment of this invention. The present embodiment differs from the fourth embodiment in the configuration of a retaining portion that holds an elongated belt-shaped spacer 30 of a spacer structure 22. According to the sixth embodiment, as shown in FIG. 21, a retaining portion 32a that holds one end portion of the spacer 30 has a fixing base 34 fixed to the inner surface of a second substrate 12 outside the image display region thereof and a buffer portion 42 that connects the fixing base and the spacer 30. The buffer portion 42 extends parallel to the spacer 30 and has a bellows structure. The buffer portion 42 is formed of, e.g., metal.

The buffer portion 42, based on the bellows structure, is designed for flexibility such that its modulus of elasticity in the direction of the tension that acts on the spacer structure 22 is lower than that of the spacer 30. In the heat treatment process, therefore, the buffer portion 42 can alternatively extend or contract to ease a stress that acts on the spacer structure 22.

A seventh embodiment shown in FIG. 22 is another form of the retaining portion of the belt-shaped spacer structure. In this case, a retaining portion 32a that holds one end portion of a spacer 30 has a pair of fixing bases 34 fixed to the inner surface of a second substrate 12 outside the image display region thereof. The fixing bases 34 are arranged spaced in the second direction Y perpendicular to the longitudinal direction of the spacer 30. A plate-like beam member 52 is stretched between these fixing bases 34 and extends in the second direction Y. The beam member 52 is set up at right angles to a surface of the second substrate 12. The beam member 52 is formed of, e.g., a metal plate, and is elastically deformable in the longitudinal direction of the spacer 30, that is, in the first direction X, as indicated by arrow D. One end of the spacer 30 is fixed to the central part of the beam member 52 with, for example, an inorganic adhesive agent.

According to the configuration described above, the beam member 52 extends at right angles to the direction of a tension that acts on the spacer 30. In the heat treatment process, therefore, the beam member 52 functions as a buffer portion that can be elastically deformed as the spacer 30 extends or contracts in the longitudinal direction, thereby easing a stress that acts on the spacer structure 22.

In the sixth and seventh embodiments described above, other configurations of each SED are the same as those of the foregoing fourth embodiment, so that like reference numerals are used to designate like portions, and a detailed description thereof is omitted. Further, the same functions and effects of the fourth embodiment can be obtained with the sixth and seventh embodiments. The configuration of the retaining portion described in connection with the seventh embodiment is also applicable to an SED that is provided with the aforementioned planar spacer structure.

The present invention is not limited directly to the embodiment described above, and its components may be embodied in modified forms without departing from the scope or spirit of the invention. Further, various inventions may be made by suitably combining a plurality of components described in connection with the foregoing embodiments. For example, some of the components according to the foregoing embodiments may be omitted. Furthermore, components according to different embodiments may be combined as required.

This invention is not limited to image display devices that use surface-conduction electron emitting elements as electron sources, but may alternatively be applied to ones that use other electron sources, such as the field-emission type, carbon nanotubes, etc.

What is claimed is:

1. An image display device comprising:
an envelope which has a first substrate and a second substrate located opposite each other with a gap therebetween and having respective peripheral portions thereof joined together; and
a spacer structure which is arranged between the first and second substrates and supports an atmospheric load acting on the first and second substrates,
the spacer structure having a plurality of retaining portions held on one of the first and second substrates outside an image display region,
at least one of the retaining portions having a tensioning mechanism which applies a tension in a direction parallel to the surfaces of the first and second substrates based on a force of pressure perpendicular to the surfaces of the first and second substrates.

2. The image display device according to claim 1, wherein the tensioning mechanism includes a connecting member which has one end portion fixed to an end portion of the spacer structure and the other end portion fixed to the one of the first and second substrates, extends at an angle to the first and second substrates, and rocks around the other end portion based on the force of pressure perpendicular to the substrate surfaces and converts the force of pressure into a tension acting on the spacer structure.

3. The image display device according to claim 1, wherein the tensioning mechanism has a press portion provided on the other of the first and second substrates and presses the one end portion of the connecting member toward the one substrate.

4. The image display device according to claim 1, wherein the retaining portion has a fixing base fixed to the inner surface of the one substrate outside the image display region and a height regulating member which is fixed to the inner surface of the one substrate with a gap between the height regulating member and the fixing base and positions the spacer structure, and the tensioning mechanism includes a press portion which is fixed to the other of the first and second substrates and applies a tension to the spacer structure in a manner such that an end portion of the spacer structure is squeezed between the fixing base and the position regulating member by the force of pressure perpendicular to the substrate surfaces.

5. An image display device comprising:
an envelope which has a first substrate and a second substrate located opposite each other with a gap therebetween and having respective peripheral portions thereof joined together; and
a spacer structure which is arranged between the first and second substrates and supports an atmospheric load acting on the first and second substrates,
the spacer structure having a plurality of retaining portions held on one of the first and second substrates outside an image display region,
at least one of the retaining portions being removably attached to the one of the first and second substrates.

6. The image display device according to claim 5, wherein the removable retaining portion has a guide member which is fixed to the one of the first and second substrates and positions the spacer structure, and a hook which is fixed to the spacer structure, removably engages the guide member, and applies tension to the spacer structure.

7. The image display device according to claim 5, wherein the removable retaining portion has a guide member which is fixed to the one of the first and second substrates and positions the spacer structure, a hook which is fixed to the spacer structure and opposed to the guide member across a gap, and a wedge member which is removably inserted between the guide member and the hook and applies a tension to the spacer structure.

8. An image display device comprising:
an envelope which has a first substrate and a second substrate located opposite each other with a gap therebetween and having respective peripheral portions thereof joined together; and
a spacer structure which is arranged between the first and second substrates and supports an atmospheric load acting on the first and second substrates,
the spacer structure having a plurality of retaining portions held on one of the first and second substrates outside an image display region,
at least one of the retaining portions having a buffer portion of which the modulus of elasticity in the direction of a tension acting on the second substrate is lower than that of the spacer structure.

9. The image display device according to claim 8, wherein the at least one retaining portion has a fixing base fixed to the one of the first and second substrates outside the image display region, and the buffer portion is stretched between an end portion of the spacer structure and the fixing base.

10. The image display device according to claim 9, wherein the buffer portion is in the form of a bellows.

11. The image display device according to claim 1, wherein the spacer structure includes a plate-shaped supporting substrate, which is opposed to the first and second substrates and has a plurality of electron beam passage apertures, and a plurality of spacers set up on the surfaces of the supporting substrate, the supporting substrate having a plurality of end portions held by the plurality of retaining portions, individually.

12. The image display device according to claim 1, wherein the spacer structure includes a plurality of plate-shaped spacers arranged side by side and parallel to one another with gaps therebetween, each of the spacers having longitudinally opposite end portions held by the retaining portions, individually.

13. The image display device according to claim 1, wherein the envelope is a vacuum envelope.

14. The image display device according to claim 1, which comprises a display surface provided on the inner surface of the first substrate and a plurality of electron emitting elements which are arranged on the inner surface of the second substrate and individually emit electrons toward the display surface.

15. A method of manufacturing an image display device which comprises an envelope which has a first substrate and a second substrate located opposite each other with a gap therebetween and having respective peripheral portions thereof joined together, and a spacer structure which is provided between the first and second substrates and supports an atmospheric load acting on the first and second substrates, the spacer structure having a plurality of retaining portions held on one of the first and second substrates outside an image display region, at least one of the retaining portions having a tensioning mechanism which applies a tension in a direction parallel to the first and second substrates based on a force of pressure perpendicular to the surfaces of the first and second substrates, the method comprising:
holding the spacer structure on at least one of the first and second substrates with the retaining portions and heat-treating the at least one substrate;
sealing the other substrate to the at least one substrate after the heat treatment; and
converting a force of pressure perpendicular to the surfaces of the first and second substrates into a tension in a direction parallel to the surfaces of the first and second substrates and applying the tension to the spacer structure by the tensioning mechanism during the sealing process.

16. The method of manufacturing a image display device according to claim 15, wherein the first and second substrates are heat-treated and sealed consistently in a vacuum ambience without breaking the vacuum ambience.

17. A method of manufacturing an image display device which comprises an envelope which has a first substrate and a second substrate located opposite each other with a gap therebetween and having respective peripheral portions thereof joined together, and a spacer structure which is provided between the first and second substrates and supports an atmospheric load acting on the first and second substrates, the spacer structure having a plurality of retaining portions held on one of the first and second substrates outside an image display region, at least one of the retaining portions being removably attached to the one of the first and second substrates, the method comprising:
heat-treating the first substrate and the second substrate;
holding the spacer structure on the one of the first and second substrates by the removable retaining portions after the heat treatment; and
sealing the heat-treated first and second substrates to each other.

18. The method of manufacturing a image display device according to claim 17, wherein the first and second substrates are heat-treated and sealed consistently in a vacuum ambience without breaking the vacuum ambience.
